(19) United States
(12) Patent Application Publication
(10) Pub. No.: US 2018/0348987 A1
(43) Pub. Date: Dec. 6, 2018

(54) METHOD EXECUTED ON COMPUTER FOR PROVIDING VIRTUAL SPACE, PROGRAM AND INFORMATION PROCESSING APPARATUS THEREFOR

(71) Applicant: COLOPL, Inc., Tokyo (JP)

(72) Inventor: Kazuaki SAWAKI, Tokyo (JP)

(21) Appl. No.: 15/995,162

(22) Filed: Jun. 1, 2018

(30) Foreign Application Priority Data
Jun. 1, 2017 (JP) 2017-109097

(51) Int. Cl. G06F 3/0481; G02B 27/01; G06T 7/73; G06F 3/0346

(52) U.S. Cl. CPC G06F 3/04815; G02B 27/017; G06T 2207/30241; G06F 3/0346; G06T 7/73

(57) ABSTRACT

A method of providing a virtual space according to at least one embodiment includes defining a virtual space, wherein the virtual space comprises a first avatar corresponding to a first user associated with a first head-mounted device (HMD) and a second avatar corresponding to a second user associated with a second HMD. The method further includes identifying a first position in the virtual space, wherein the first position is associated with the first avatar. The method further includes defining a visual field in the virtual space in accordance with the first position. The method further includes outputting a visual-field image corresponding to the visual field to the first HMD. The method further includes identifying a second position in the virtual space, wherein the second position is associated with the second avatar. The method further includes receiving a command to move the second avatar to a third position in the virtual space. The method further includes displaying, in response to the reception of the command, a trajectory indicating movement of the second avatar from the second position to the third position in the visual-field image.

### TECHNICAL FIELD

This disclosure relates to a technology of providing a virtual space, and more particularly, to a technology of providing a virtual space including a moving object.

### BACKGROUND

There is known a technology of providing a virtual reality through use of a head-mounted device (HMD). For example, in Japanese Patent Application Laid-open No. 2016-218774 (Patent Document 1), there is described a technology of moving an object in a virtual space through operation by a player.

### PATENT DOCUMENTS

[Patent Document 1] JP 2016-218774 A

### SUMMARY

According to one embodiment of the present invention, there is provided a method of providing a virtual space, the method including: defining the virtual space, the virtual space including a first avatar corresponding to a first user associated with a first head-mounted device (HMD) and a second avatar corresponding to a second user associated with a second HMD; identifying a first position in the virtual space, the first position being associated with the first avatar; defining a visual field in the virtual space in accordance with the first position; outputting a visual-field image corresponding to the visual field to the first HMD; identifying a second position in the virtual space, the second position being associated with the second avatar; receiving a command to move the second avatar to a third position in the virtual space; and displaying, in response to the reception of the command, a trajectory indicating movement of the second avatar from the second position to the third position in the visual-field image.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

controller 300

FIG. 15 A sequence chart of a part of processing to be executed by a system including an HMD according to at least one embodiment of this disclosure.

FIG. 16 A diagram of a change in field-of-view image at a time of movement of an object according to at least one embodiment of this disclosure.

FIG. 17 A table of one mode of storage of chat monitor information in a memory module 530 according to at least one embodiment of this disclosure.

FIG. 18 A table of one mode of storage of object information in the memory module 530 according to at least one embodiment of this disclosure.

FIG. 19 A diagram of an example of a mode of change in relative positions of a virtual camera and the object according to at least one embodiment of this disclosure.

FIG. 20 A diagram of another example of the mode of change in relative positions of the virtual camera and the object according to at least one embodiment of this disclosure.

FIG. 21 A diagram of a change in field-of-view image that follows change in relative positions of a virtual camera 14 and an object 6 illustrated in FIG. 20 according to at least one embodiment of this disclosure.

FIG. 22 A diagram of generation of a trajectory object according to at least one embodiment of this disclosure.

FIG. 23 A diagram of generation of the trajectory object according to at least one embodiment of this disclosure.

FIG. 24 A diagram of generation of the trajectory object according to at least one embodiment of this disclosure.

FIG. 25 A flowchart of processing of displaying a complement image to be executed by a processor according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

### Configuration of HMD System

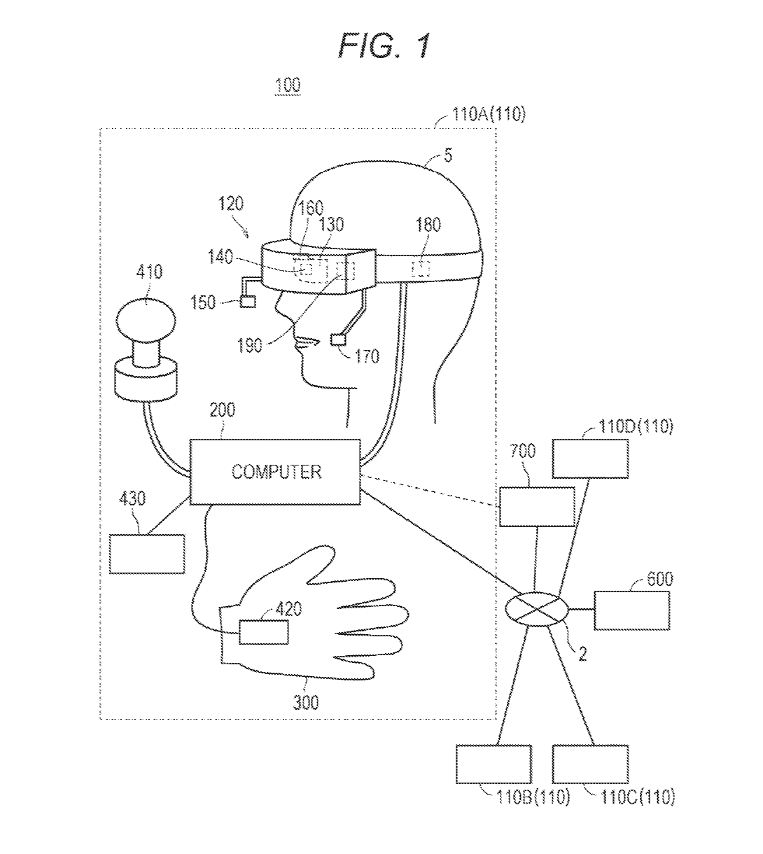

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or store. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 130 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eve of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

### Hardware Configuration of Computer

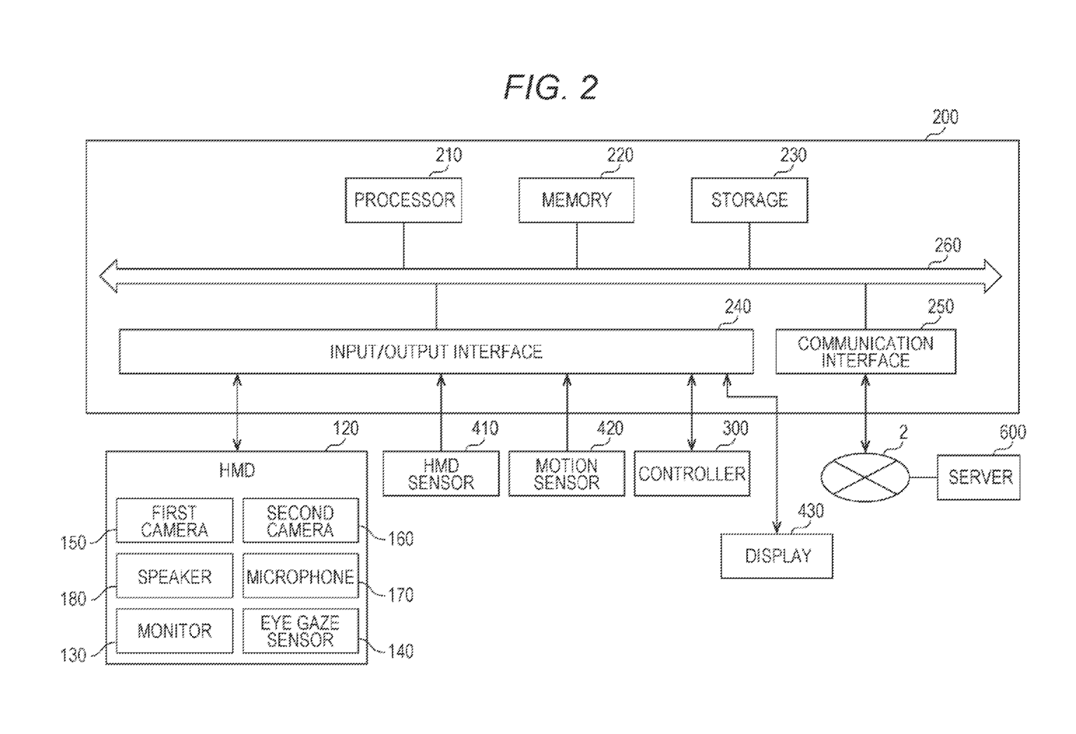

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central, processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (SAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

### Uvw Visual-Field Coordinate System

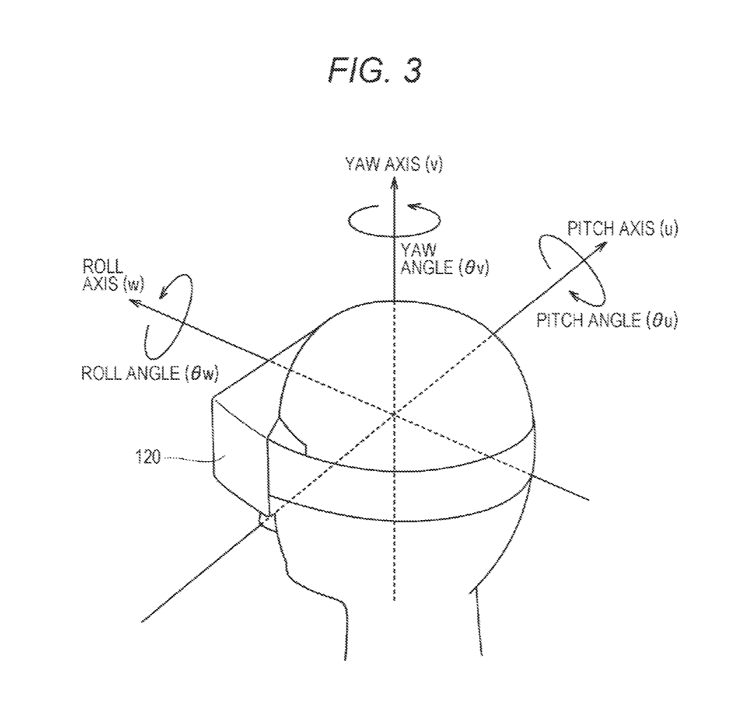

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction, (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the rear space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

### Virtual Space

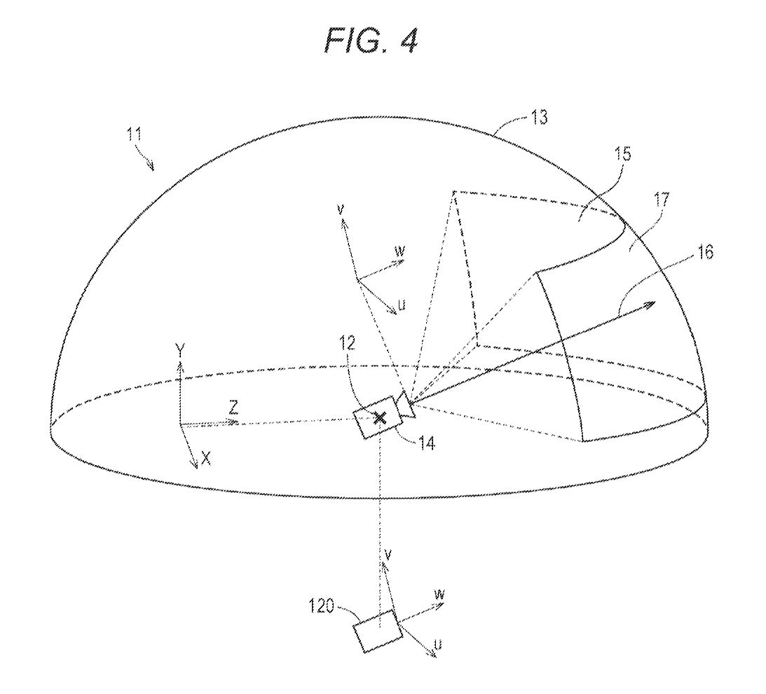

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

### User's Line of Sight

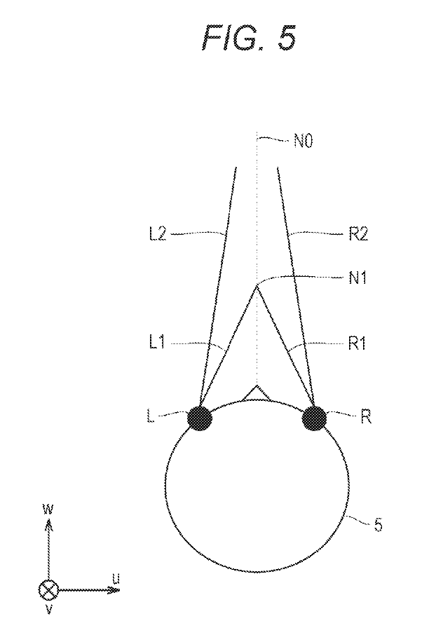

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

### Field-of-View Region

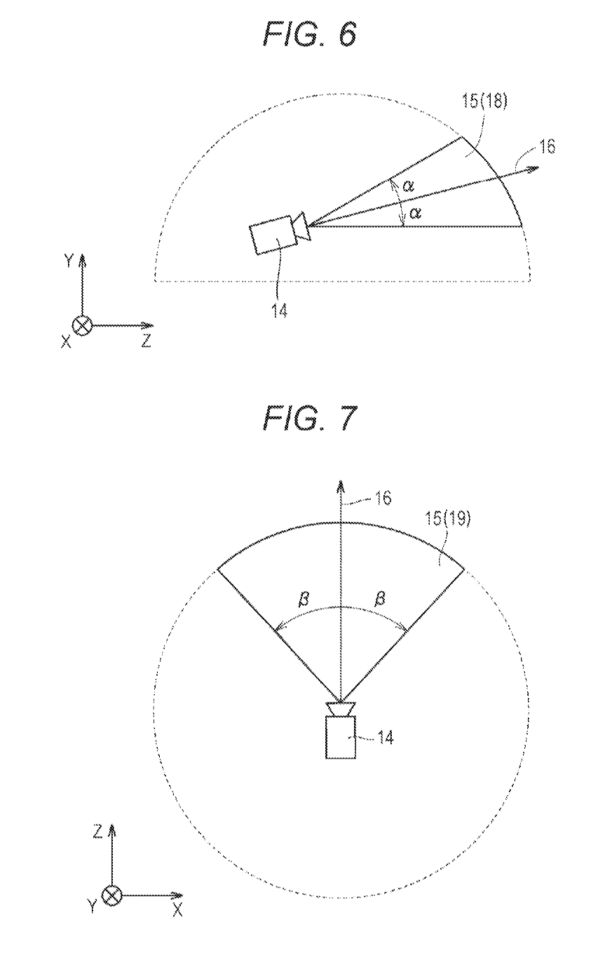

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 5, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section induces a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 11 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the positron of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the positron or inclination of the virtual camera 11, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

### Controller

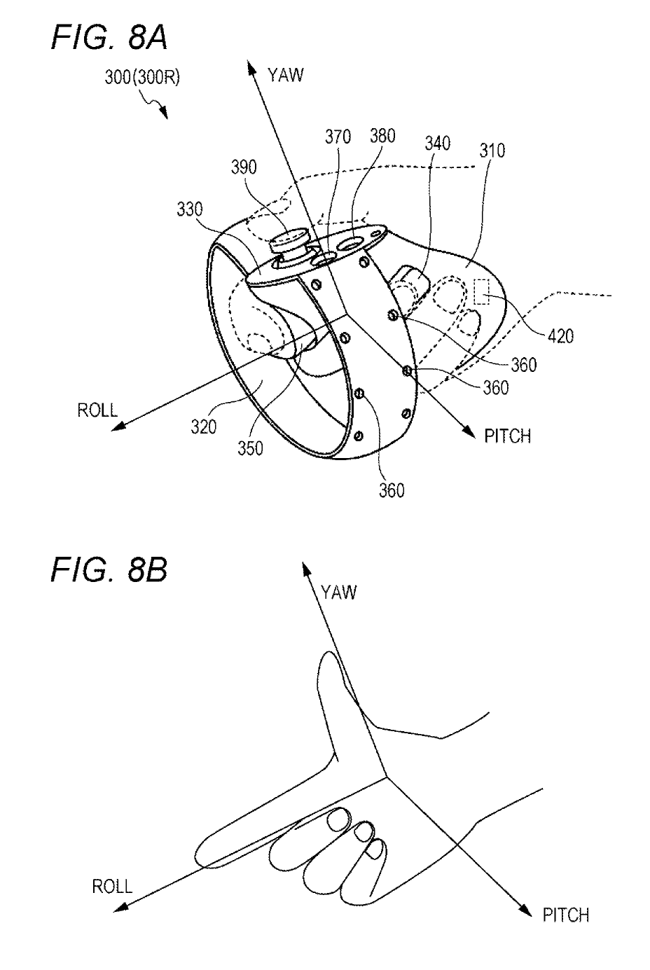

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least, one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In as least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the comparer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

### Hardware Configuration of Server

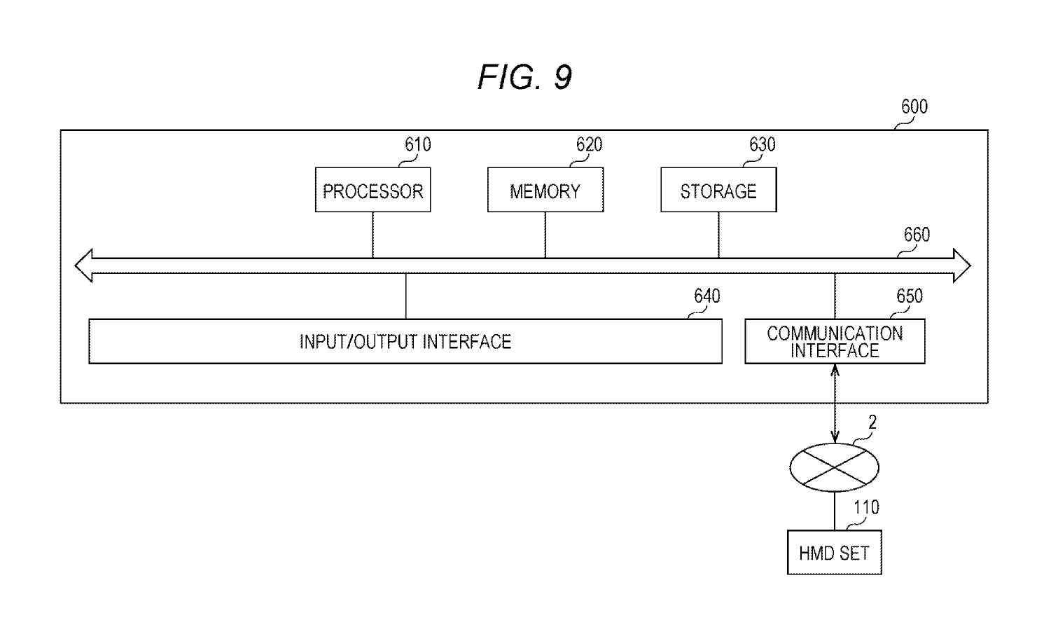

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or sore programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

### Control Device of HMD

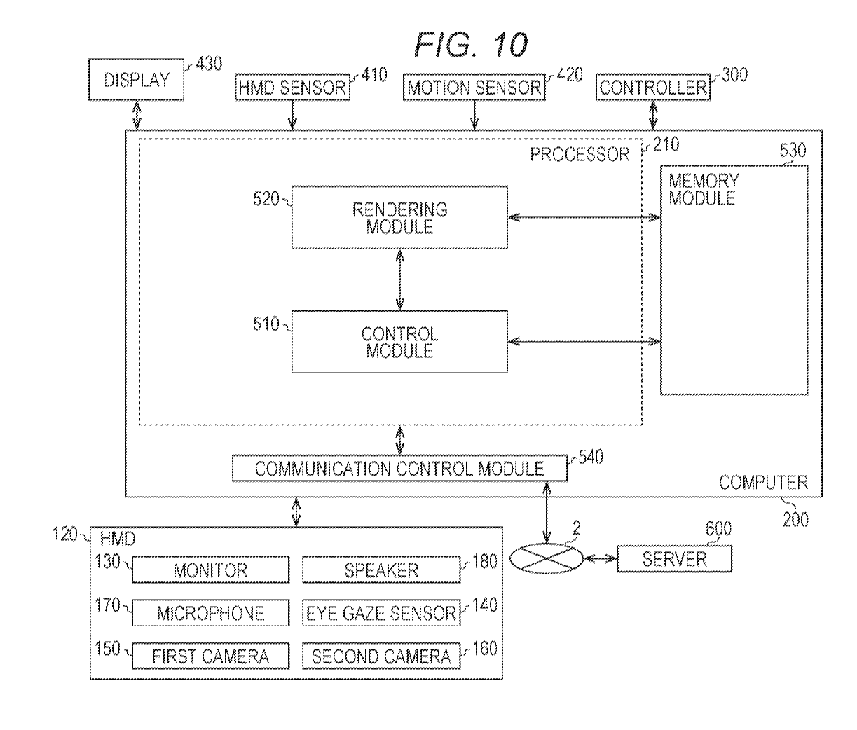

With reference to FIG. 10, the control device of the HMD 120 is described. According so at least one embodiment of this disclosure, the control device is implemented by the computer 200 having a known configuration. FIG. 10 is a block, diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the baud of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

### Control Structure of HMD System

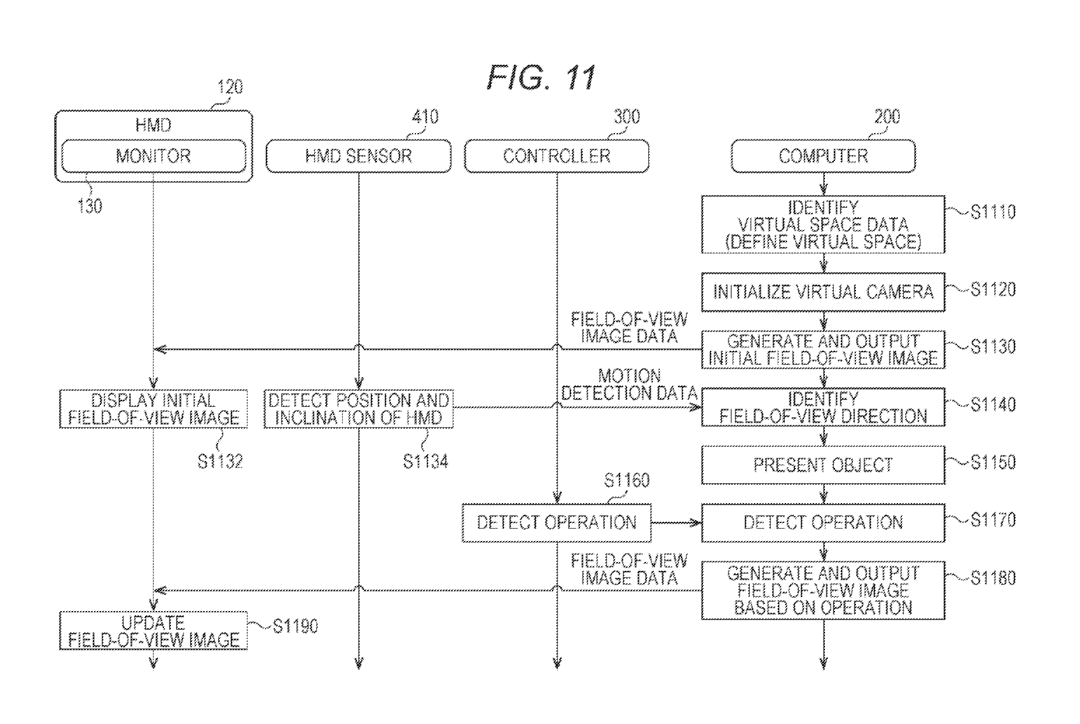

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

### Avatar Object

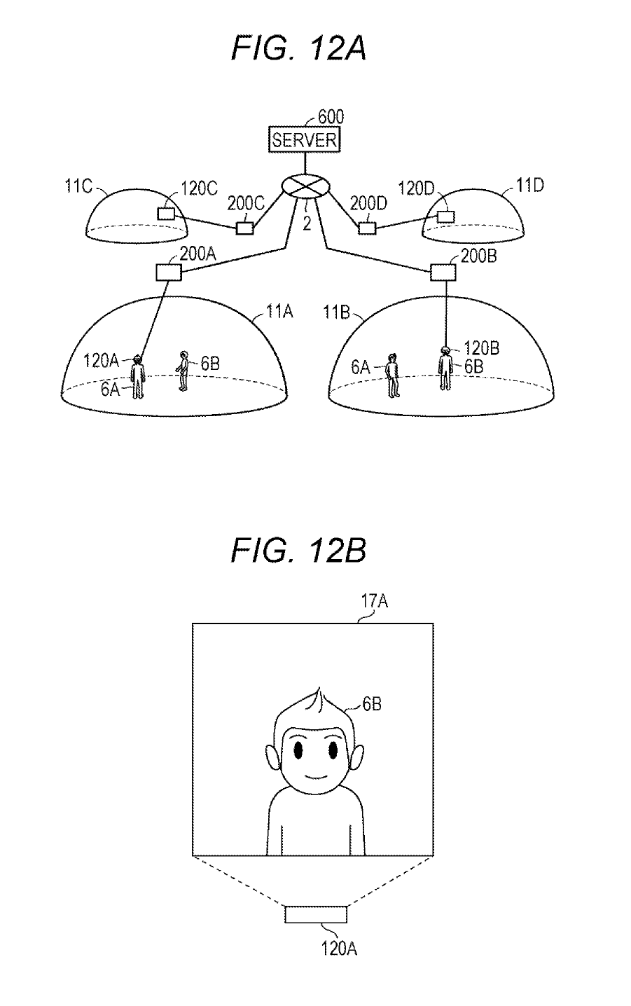

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 5B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

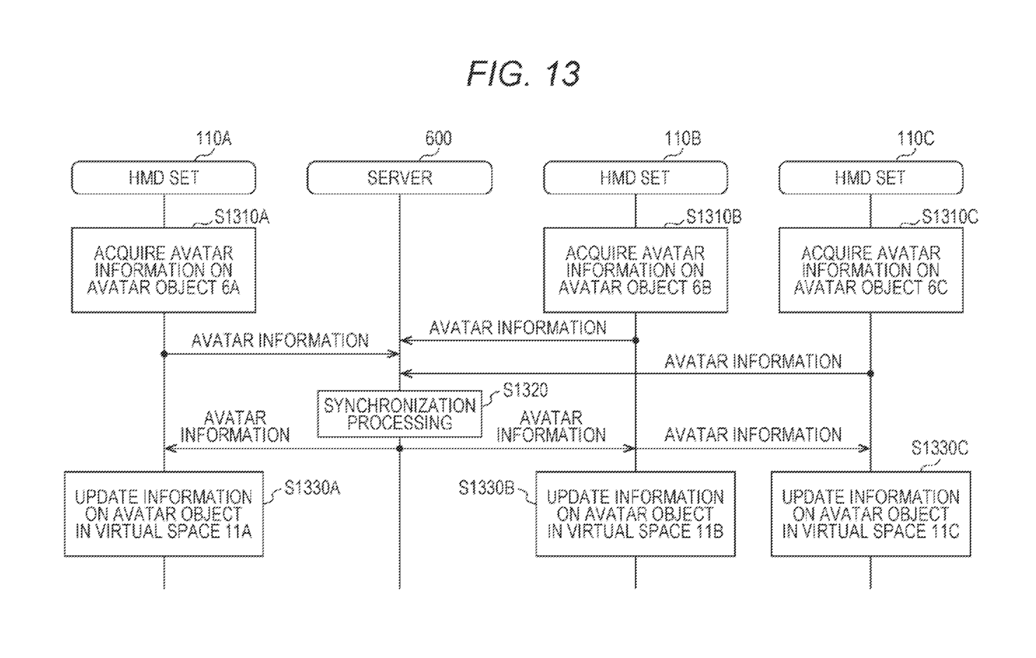

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction, of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

### Detailed Configuration of Modules

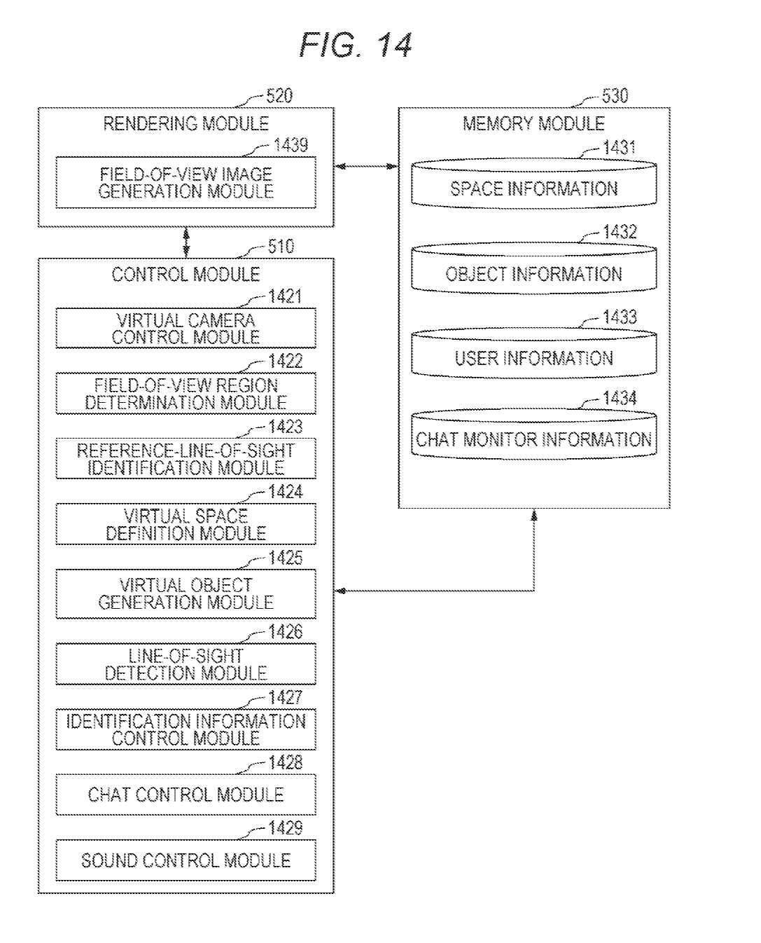

Now, with reference to FIG. 14, a description is given of details of a module configuration of the computer 200. FIG. 14 is a block, diagram of the detailed configuration of modules of the computer 200 according to at least one embodiment of this disclosure.

In FIG. 14, the control module 510 includes a virtual camera control module 1421, a field-of-view region determination module 1422, a reference-line-of-sight identification module 1423, a virtual space definition module 1424, a virtual object generation module 1425, a line-of-sight detection module 1426, an identification information control module 1427, a chat control module 1428, and a sound control module 1429. The rendering module 520 includes a field-of-view image generation module 1439. The memory module 530 stores space information 1431, object information 1432, user information 1433, and chat monitor information 1434.

In at least one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 based on the direction of the head of the user 5 wearing the HMD 120. The field-of-view image generation module 1439 generates a field-of-view image to be displayed on the monitor 130 based on the determined field-of-view region 15. Further, the field-of-view image generation module 1439 generates a field-of-view image based on data received from the control module 510. Data on the field-of-view image generated by the field-of-view image generation module 1439 is output to the HMD 120 by the communication control module 540. The reference-line-of-sight identification module 1423 identifies the line-of-sight of the user 5 based on a signal from the eye gaze sensor 140.

The sound control module 1429 detects that a sound signal that is based on utterance of the user 5 has been input from the HMD 120 into the computer 200. The sound control module 1429 assigns an input time to a sound signal corresponding to the utterance to generate sound data. The sound control module 1429 transmits the sound data to a computer used by a user selected by the user 5 among the other computers 200A and 200B, with which the computer 200 can communicate as a chat partner of the user 5.

The control module 510 controls the virtual space 11 to be provided to the user 5. First, the virtual space definition module 1424 generates virtual space data representing the virtual space 11, to thereby define the virtual space 11 in the HMD system 100.

The virtual object generation module 1425 generates data on objects to be arranged in the virtual space 11. For example, the virtual object generation module 1425 generates data on avatar objects representing the other users 5A and 5B chatting with the user 5 via the virtual space 11. Further, the virtual object generation module 1425 may change the lines of sight of the avatar objects of the other users 5A and 5B based on the lines of sight detected through utterance by those users.

The line-of-sight detection module 1426 detects the line of sight of the user 5 based on output from the eye gaze sensor 140. In at least one aspect, the line-of-sight detection module 1426 detects, based on detection of utterance by the user 5, the line of sight of the user 5 at the time of detection. Detection of the line of sight is implemented by a known technology, for example, non-contact eye-tracking. As an example, as in the case of a limbus reflection method, the eye gaze sensor 140 may detect a motion of the line of sight of the user 5 based on data obtained by radiating an infrared ray to the eyes of the user 5 and photographing the reflected light with a camera (not shown). In at least one aspect, the line-of-sight detection module 1426 identifies each position that depends on the motion of the line of sight of the user 5 as coordinate values (x, y) having any point on the display region of the monitor 130 as its origin.

### Presentation of Identification Information

The identification information control module 1427 controls presentation of identification information on avatar objects to be presented in the virtual space 11. For example, in at least one aspect, the identification information control module 1427 detects that the line of sight of the user 5 is directed to an avatar object presented in the virtual space 11 based on output from the eye gaze sensor 140. The identification information control module 1427 presents identification information on the other users (e.g., users 5A and 5B) corresponding to the avatar objects. The identification information contains, for example, names, screen names and other similar names, and information distinguishing one user from the other users.

In at least one aspect, the identification information control module 1427 presents an object representing identification information so that the object faces toward the viewpoint of the user 5 independently of the direction of the avatar object. For example, the identification information control module 1427 outputs, to the monitor 130, data for rendering an image representing identification information so that the image faces toward the front of the user 5. The user 5 can easily know which user is using the avatar object.

In at least one aspect, the identification information control module 1427 measures a period that has elapsed since presentation of the identification information. When the elapsed period exceeds a predetermined period (e.g., several, seconds), the identification information control module 1427 ends presentation of the identification information. With this, the identification information that has been recognized by the user 5 does not continue to be presented in the virtual space 11, and thus it is possible to prevent other objects arranged in the virtual space 11 from being obscure.

In at least one aspect, after identification information on the other users 5A and 5B is deleted, the identification information control module 1427 detects that the line of sight of the user 5 is directed to the avatar objects of the others 5A and 5B again based on output from the eye gaze sensor 140. In this case, the identification information control module 1427 does not present the identification information on the other users 5A and 5B again. The user 5 already recognizes the other users 5A and 5B, and thus it is possible to prevent unrequired identification information from being presented again in the virtual space 11 in a disturbing manner.

In at least one aspect, the identification information control module 1427 presents, in the HMD 120, the avatar objects of the other users 5A and 5B, for which identification information is already displayed, in a manner different from an avatar object for which identification information is not displayed yet. With this, the user 5 can easily distinguish between avatar objects for which identification information is already displayed and the other avatar objects.

In at least one aspect, the identification information control module 1427 detects movement of an avatar object in the virtual space 11 based on a signal transmitted from the server 600. For example, the other users 5A and 5B may move their own avatar objects by operating the controllers 300. In such a case, the virtual object generation module 1425 presents those avatar objects at movement destination locations. The identification information control module 1427 presents pieces of identification information near the avatar objects after movement. With this, even when the locations of the avatar objects corresponding to the other respective users 5A and 5B in the virtual space 11 have changed in synchronization with the motions of those users during presentation of the pieces of identification information, the respective pieces of identification information are also presented near those avatar objects. The user 5 can accurately identify the other users 5A and 5B without overlooking association between the pieces of identification information and the avatar objects.

In at least one aspect, the identification information control module 1427 detects that communication to/from the other user 5A or user 5B is disconnected based on a signal received from the server 600. Communication may be disconnected, for example, when a communication line is unstable, when a radio wave used in a mobile communication network is disconnected, or when a power failure has occurred. The identification information control module 1427 may end presentation of an avatar object and identification information in response to disconnection of communication. When the identification information control module 1427 detects that the disconnected communication to/from the other users is established again based on a signal received from the server 600, the identification information control module 1427 may present an avatar object in the virtual space 11.

When communication is disconnected and established again within a predetermined period of time, the identification information control module 1427 may present an avatar object and identification information again. In a case where communication is disconnected under a state in which identification information is presented, when the disconnected period of time is short, the user 5 can easily recognize an avatar object and identification information again, to thereby easily recognize another user using that avatar object.

On the contrary, in a case where the disconnected period of time is long, when an avatar object is presented in the virtual space 11 again, the user 5 may not recognize that avatar object. In this case, when the user 5 recognizes the avatar object again, the identification information control module 1427 may present identification information near the avatar object again.

Further, in at least one aspect, the identification information control module 1427 presents pieces of identification information on the other users 5A and 5B only when the other users 5A and 5B permit presentation of the identification information. For example, at the time of user registration in a VR chat, each user who wishes to register with the VR chat may set whether to permit disclosure of his or her private information. Users who do not wish to disclose his or her real names, photos, and other pieces of private information can register, with the server 600, the setting of prohibiting disclosure of the private information. In such a case, the user can enjoy a VR chat with only an avatar object without disclosure of the private information in a chat room. Thus, when a specific user enables such a setting, the identification information control module 1427 does not display identification information even when the user 5 keeps looking at the avatar object.

The chat control module 1428 controls communication via the virtual space. In at least one aspect, the chat control module 1428 reads a chat application from the memory module 530 based on an operation by the user 5 or based on a request to start a chat transmitted by another computer 200A, to thereby start communication via the virtual space 11. When the user 5 performs an operation for login to the computer 200 by inputting a user ID and a password, the user 5 is associated with a session (also referred to as “room”) of a chat via the virtual space 11 as a member of that chat. After that, when the user 5A using the computer 200A logs in to a chat in that session, the user 5 and the user 5A are associated with each other as members of that chat. When the chat control module 1428 recognizes the user 5A of the computer 200A being a partner of communication to/from the computer 200, the virtual object generation module 1425 uses the object information 1432 to generate data for presenting an avatar object corresponding to the user 5A, and outputs the data to the HMD 120. When the HMD 120 displays an avatar object corresponding to the user 5A on the monitor 130 based on the data, the user 5 wearing the HMD 120 recognizes the avatar object in the virtual space 11.

In at least one embodiment, the chat control module 1428 waits for input of sound data that is based on utterance of the user 5 and input of data from the eye gaze sensor 140. The user 5, which has performed an operation (e.g., operation of controller, gesture, selection by voice, or gaze by line of sight) for selecting an avatar object in the virtual space 11, the chat control module 1428 detects that a user (e.g., user 5) corresponding to the avatar object is selected as a chat partner based on the operation. The chat control module 1428, which has detected utterance by the user 5, transmits sound data that is based on a signal transmitted from the microphone 170 and eye tracking data that is based on a signal transmitted from the eye gaze sensor 140 to the computer 200A via the communication control module 540 based on a network address of the computer 200A used by the user 5A. The computer 200A updates the line of sight of the avatar object of the user 5 based on the eye tracking data, and transmits the sound data to the HMD 120A. When the computer 200A has a synchronization function, change in line of sight of an avatar object on the monitor 130 and output of a sound from the speaker 180 are implemented at the substantially same timing, and thus the user 5A is less likely to feel strange.

The memory module 530 stores data to be used by the computer 200 to provide the user 5 with the virtual space 11. In at least one aspect, the memory module 530 stores space information 1431, object information 1432, user information 1433, and chat monitor information 1434.

The space information 1431 stores one or more templates that are defined to provide the virtual space 11.

The object information 1432 holds data for displaying an avatar object to be used for communication via the virtual space 11, content to be reproduced in the virtual space 11, and information for arranging objects to be used in the content. The content may contain, for example, a game or content representing a scenery similar to that of a real society. The data for displaying an avatar object may contain, for example, image data schematically representing a communication partner with which a relationship is established in advance as a chat partner and a photograph of that communication partner.

The user information 1433 holds a program for causing the computer 200 to function as a control device for the HMD system 100, an application program, using each piece of content held in the object information 1432, and a user ID and password that are required to execute the application program. The data and program stored in the memory module 530 are input by the user 5 of the HMD 120. In other cases, the processor 210 downloads a program or data from a computer (e.g., server 600) operated by a business operator providing the content, and stores the downloaded program or data into the memory module 530.

The chat monitor information 1434 contains information on communication via the virtual space 11 shared among the computer 200 and the other computers 200A and 200B. The chat monitor information 1434 contains, for example, identification information on each user participating in a chat using the virtual space 11, a login status of each user, data for controlling whether to present identification information, or a date and time at which the identification information is presented to the user 5 last.

In at least one aspect, when each user logs in to a chat room prepared in advance for a VR chat, information on the login user is transmitted to a computer used by another user who has logged in to the chat room. For example, when the users 5A and 5B log in to the chat room, the user ID, identification information, login status (e.g., “logged in”), and whether to permit presentation of the identification information for each of the users 5A and 5B are transmitted from each of the computers 200A and 200B to the computer 200 of the user 5.

### 2. Operation Between Computers Through Communication Between Users

Now, a description is given of operations of the computers 200A and 200B in a case where the two users 5A and 5B communicate to/from each other via the virtual space 11. Now, a description is given of a case in which the user 5A wearing the HMD 120A connected to the computer 200A utters a sound to the user 5B wearing the HMD 120B connected to the computer 200B.

### Transmission Side

In at least one aspect, the user 5A wearing the HMD 120A utters a sound toward the microphone 170 in order to chat with the user 5B. A sound signal of utterance is transmitted to the computer 200A connected to the HMD 120A. The sound control module 1429 converts the sound signal into sound data, and associates a timestamp representing a time of detection of utterance with the sound data. The time stamp is, for example, time data on an internal clock of the processor 210. In at least one aspect, time data on a time when the sound signal is converted into the sound data by the communication control module 540 is used as the time stamp.

When the user 5A is uttering a sound, the motion of the line of sight of the user 5A is detected by the eye gaze sensor 140. A result (eye tracking data) of detection by the eye gaze sensor 140 is transmitted to the computer 200A. The line-of-sight detection module 1426 determines each position (e.g., position of pupil) representing a change in line of sight of the user 5A based on the result of detection.

The computer 200A transmits the sound data and eye tracking data to the computer 200B. The sound data and eye tracking data are first transmitted to the server 600. The server 600 refers to a destination in each header of the sound data and eye tracking data, and transmits the sound data and eye tracking data to the computer 200B. At this time, the sound data and the eye tracking data may not arrive at the computer 200B at the same timing.

### Reception Side

The computer 200B receives data, which is transmitted from the computer 200A, from the server 600. In at least one aspect, the processor 210B of the computer 200B detects reception of sound data based on the data transmitted from the communication control modulo 540. When the processor 210B identifies the transmission source (i.e., computer 200A) of the sound data, the processor 210B serves as the chat control module 1428 to display a chat screen on the monitor 130 of the HMD 120B.

The processor 210B further detects reception of eye tracking data. When the processor 210B identifies the transmission source (i.e., computer 200A) of the eye tracking data, the processor 210 serves as the virtual object generation module 1425 to generate data for displaying the avatar object of the user 5A.

In at least one aspect, the processor 210B receives eye tracking data before sound data. In this case, when the processor 210B detects a transmission source identification number from the eye tracking data, and the processor 210B determines that there is sound data transmitted in association with the eye tracking data. The processor 210B waits for output of data for displaying an avatar object until sound data containing the same transmission source identification number and time data as the transmission source identification number and time data contained in the eye tracking data is received.

Further, in at least one aspect, the processor 210B receives sound data before eye tracking data. In this case, when the processor 210B detects a transmission source identification number from the sound data, the processor 210B determines that there is eye tracking data transmitted in association with the sound data. The processor 210B waits for output of sound data until eye tracking data containing the same transmission source identification number and time data as the transmission source identification number and time data contained in the sound data is received.

In each of the above-mentioned aspects, time data for comparison is not required to completely indicate the same time.

When the processor 210B confirms reception of sound data and eye tracking data containing the same time data, the processor 210 outputs the sound data to the speaker 180, and outputs, to the monitor 130, data for displaying an avatar object in which change based on the eye tracking data is translated. As a result, the user 5B can recognize the sound uttered by the user 5A and the avatar object of the user 5A at the same timing. Therefore, the user 5 can enjoy a chat without feeling a time lag (e.g., deviation between change in avatar object and timing of sound output) due to transfer delay of a signal.

Similarly to the above-mentioned processing, the processor 210A of the computer 200A used by the user 5A can also synchronize the timing of outputting sound data and the timing of outputting an avatar object in which the motion of the line of sight of the user 5B is translated. As a result, the user 5A can also recognize the output of a sound uttered by the user 5B and the change in avatar object at the same timing. Therefore, the user 5A can enjoy a chat without feeling a time lag due to transfer delay of a signal.

### Control Structure

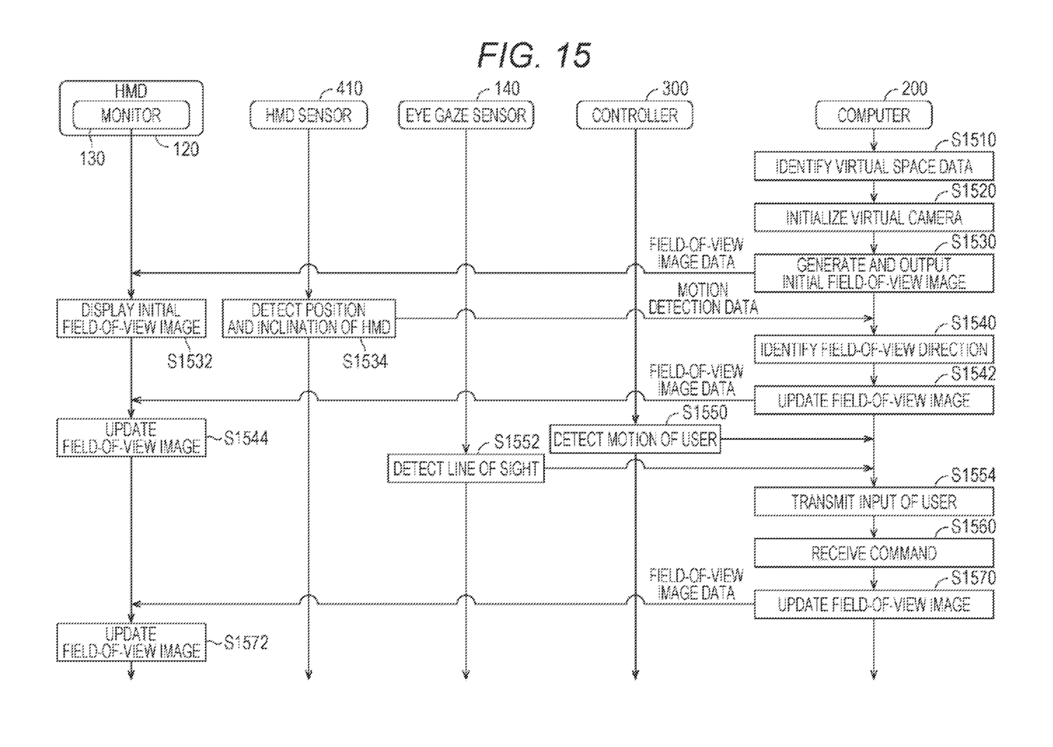

Now, with reference to FIG. 15, a description is given of the control structure of the HMD system 100. FIG. 15 is a sequence chart of a part of processing to be executed by the HMD system 100 according to at least one embodiment of this disclosure.

In Step S1510, the processor 210 of the computer 200 serves as the virtual space definition module 1424 to identify virtual space image data.

In Step S1520, the processor 210 initializes the virtual camera 14. For example, the processor 210 arranges the virtual camera 14 at the center defined in advance in the virtual space 11, and matches the line of sight of the virtual camera 14 with the direction in which the user 5 faces.

In Step S1530, the processor 210 serves as the field-of-view image generation module 1439 to generate field-of-view image data for displaying an initial field-of-view image. The generated field-of-view image data is transmitted to the HMD 120 by the communication control module 540 via the field-of-view image generation module 1439.

In Step S1532, the monitor 130 of the HMD 120 displays the field-of-view image based on the signal received from the computer 200. The user 5 wearing the HMD 120 may recognize the virtual space 11 through visual recognition of the field-of-view image.

In Step S1534, the HMD sensor 410 detects the position and the inclination of the HMD 120 based on a plurality of infrared rays emitted from the HMD 120. The detection results are transmitted to the computer 200 as motion detection data.

In Step S1540, the processor 210 identifies a field-of-view direction of the user 5 wearing the HMD 120 based on the position and inclination of the HMD 120. The processor 210 executes an application program, and displays an object in the virtual space 11 based on a command contained in the application program. The user 5 enjoys content visually recognizable in the virtual space 11 through execution of the application program.

In Step S1542, the processor 210 updates the field-of-view image based on the determined state of a virtual user. The virtual user is, for example, a user wearing the HMD 120 connected to the computer 200 including the processor 210. Then, the processor 210 outputs data (field-of-view image data) for displaying the updated field-of-view image to the HMD 120.

In Step S1544, the monitor 130 of the HMD 120 updates the field-of-view image based on the received field-of-view image data, and displays the updated field-of-view image.

In Step S1550, the controller 300 detects an operation of the user 5. A signal indicating the detected operation is transmitted to the computer 200. In at least one embodiment, the signal contains an operation of changing the position of an avatar corresponding to the user 5 in the virtual space. In at least one embodiment, the signal contains an operation of changing the position of the virtual camera 14 corresponding to the field-of-view image provided to the user 5.

In Step S1552, the eye gaze sensor 140 detects the line of sight of the user 5. A signal indicating a detection value representing the detected line of sight is transmitted to the computer 200. Herein, directing the point of gaze to an avatar is also treated as “specifying an avatar”.

In other words, in at least one embodiment, the computer 200 treats the virtual user as having specified an avatar when the user 5 operates the controller 300 to touch the avatar with a virtual hand and/or direct the point of gaze of the user 5 to the avatar.

In Step S1554, the processor 210 transmits input indicating specification of an avatar by the virtual user to the server 600.

The server 600 receives, from the processor 210 of each computer 200, input of specification of a user in the virtual space by each virtual user. The server 600 matches two or more users among a plurality of users participating in a matching system based on the fact that the input satisfies a predetermined condition. The server 600 transmits a predetermined command to the processor 210 of the computer 200 used by each of the matched users.

In Step S1560, the processor 210 receives a predetermined command from the server 600.

In Step S1570, the processor 210 updates the field-of-view screen in response to a command from the server 600, and outputs data (field-of-view image data) for displaying the updated field-of-view image to the HMD 120.

In Step S1572, the monitor 130 of the HMD 120 updates a field-of-view image based on the received field-of-view image data, and displays the updated field-of-view image.

### Outline of Disclosure

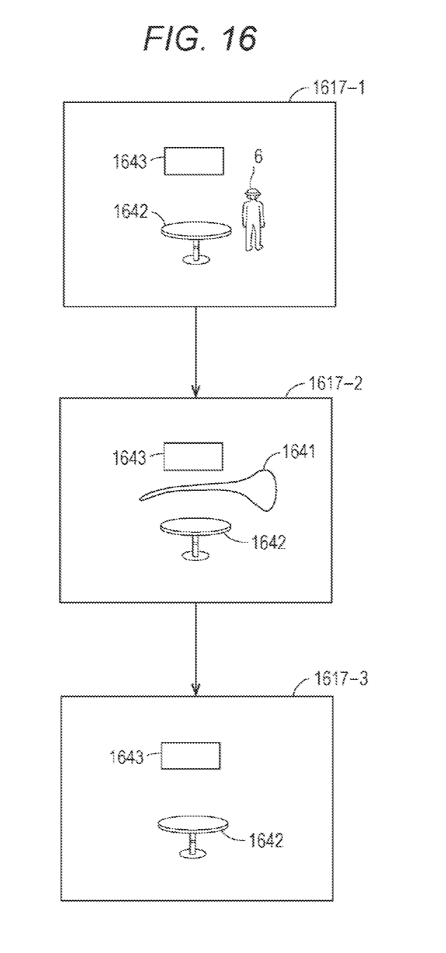

Referring to FIG. 16, a description is given of display of a complement image in a case where an object moves in the virtual space. In at least one embodiment, the complement image refers to an image for displaying an image (trajectory object) representing a trajectory of a moving object. FIG. 16 is a diagram of a change in field-of-view image at a time of movement of an object, and contains field-of-view images 1617-1, 1617-2, and 1617-3 according to at least one embodiment of this disclosure.

Referring to FIG. 16, the computer first displays the field-of-view image 1617-1. The field-of-view image 1617-1 contains an object 6 together with objects 1642 and 1643. The object 1642 is, for example, an object representing a table. The object 1643 is, for example, an object representing a screen. The object 6 is, for example, an avatar object corresponding to a user different from a user of an HMD displaying the field-of-view image 1617-1.

Next, the computer displays the field-of-view image 1617-2 after the field-of-view image 1617-1. The field-of-view image 1617-2 contains a trajectory object 1641. The field-of-view image 1617-2 is an example of the complement image.

The trajectory object 1641 represents, for example, an elastic body extending from the position of the object 6 in the field-of-view image 1617-1. In the example of FIG. 16, the object 6 moves leftward at a next time point of a time point at which the object 6 is displayed in the field-of-view image 1617-1. In response to this movement, the trajectory object 1641 represents an elastic body extending from right to left.

The position at a right end of the trajectory object 1641 in the field-of-view image 1617-2 corresponds to a position of the object 6 in the field-of-view image 1617-1. The position of the end of the trajectory object 1641 is not limited to the position of the object 6 as long as the trajectory object 1641 represents the movement path of the object 6 as described later.

After that, the computer displays the field-of-view image 1617-3. The field-of-view image 1617-3 does not contain the object 6.

As described above with reference to FIG. 16, when the object 6 in the field-of-view image 1617-1 moves out of the field-of-view image 1617-1, the computer displays the field-of-view image 1617-2 containing the trajectory object 1641 before display of the field-of-view image 1617-3, which does not contain the object 6.

### Data Structures

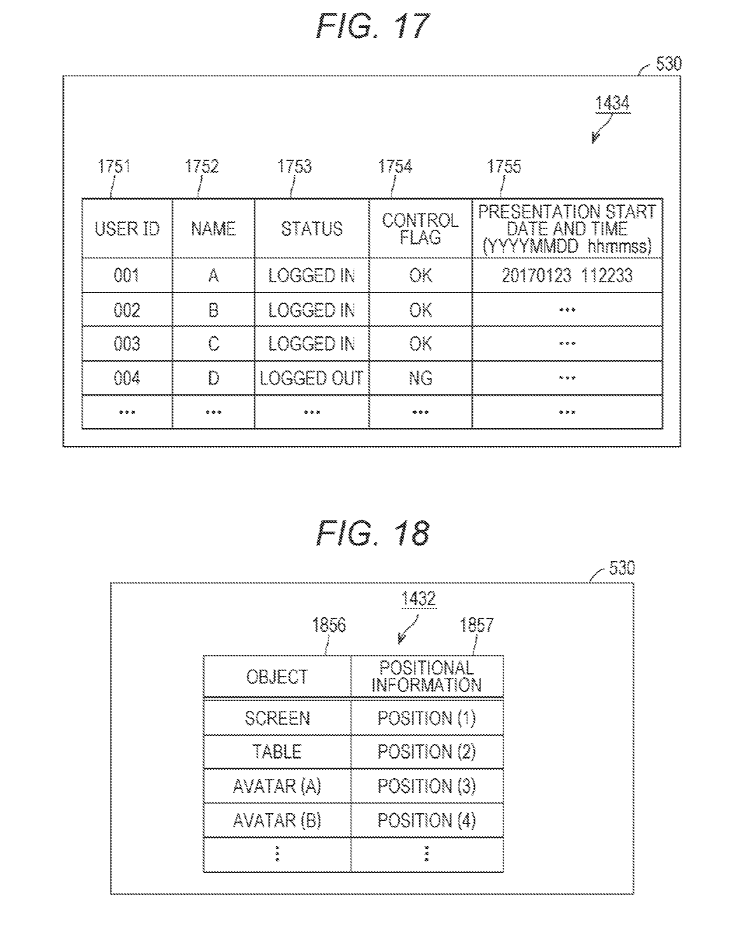

Now, a description is given of a data structure of the memory module 530 with reference to FIG. 17 and FIG. 18. Chat monitor information shown in FIG. 17 and object information shown in FIG. 18 may be stored in a chat information storage (not shown) of the server 600 by, for example, being transmitted from each computer 200 to the server 600.

### Chat Monitor Information

FIG. 17 is a table of one mode of storage of chat monitor information in the memory module 530 according to at least one embodiment of this disclosure. In at least one aspect, the memory module 530 holds the chat monitor information 1434. The chat monitor information 1434 contains a user ID 1751, a name 1752, a status 1753, a control flag 1754, and a presentation start date and time 1755.

The user ID 1751 identifies users sharing the virtual space 11. The name 1752 is used for giving a notification to each user sharing the virtual space 11. The name 1752 may be any one of, for example, the real name or screen name of the user. The status 1753 represents a state indicating whether the user has logged in to a chat room held in the virtual space 11. The control flag 1754 controls whether to permit presentation of identification information (e.g., real name or screen name) of the user to another user. The presentation start date and time 1755 represents a date and time at which the identification information on the user is first presented in a certain session in the chat room held in the virtual space 11. In at least one aspect, the presentation start date and time 1755 is reset each time the session of a chat ends. Thus, when a presentation condition on identification information is satisfied again in the next session, identification information on a user whose identification information has already been presented may be presented newly.

### Object Information

FIG. 18 is a table of one mode of storage of object information in the memory module 530 according to at least one embodiment of this disclosure. In at least one aspect, the memory module 530 stores the object information 1432. The object information 1432 contains an object ID 1856 and positional information 1857.

The object ID 1856 identifies each object arranged in the chat room. For example, “screen” and “table” of FIG. 18 correspond to “object 1643” and “object 1642” of, for example, FIG. 16, respectively. “Avatar (A)” and “avatar (B)” correspond to avatar objects respectively corresponding to the users 5A and 5B.

The positional information 1857 identifies the position, of each object in the virtual space. In the example of FIG. 18, each of positions (1) to (4) represents, for example, three-dimensional coordinates in the virtual space.

### Change in Relative Positions of Virtual Camera and Object

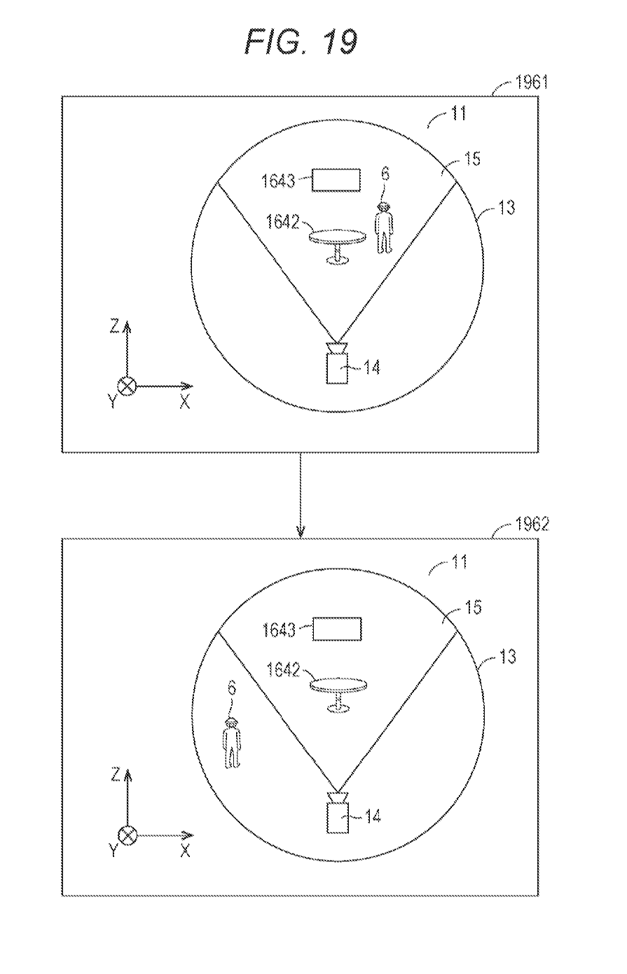

Referring to FIG. 19 to FIG. 21, a description is givers of two modes of change in relative positions of the virtual camera and the object.

FIG. 19 is a diagram of an example of a first mode of change in relative positions of the virtual camera and the object according to at least one embodiment of this disclosure. In the first mode, the position of the virtual camera 14 does not change, but the position of the object in the virtual space changes.

More specifically, in FIG. 19, two states 1961 and 1962 of the virtual space are illustrated. The states 1961 and 1962 each contain the objects 6, 1642, and 1643 described with reference to FIG. 16.

Under the state 1961, the object 6 is positioned inside the field-of-view region 15. On the other hand, under the state 1962, the object 6 is positioned outside the field-of-view region 15. In other words, the position of the object 6 in the virtual space changes between the state 1961 and the state 1962. The position of the virtual camera 14 does not change between the state 1961 and the state 1962.

The field-of-view image 1617-1 of FIG. 16 corresponds to the field-of-view region 15 in the state 1961 within the virtual space image 13. The field-of-view image 1617-3 of FIG. 16 corresponds to the field-of-view region 15 in the state 1962 within the virtual space image 13.

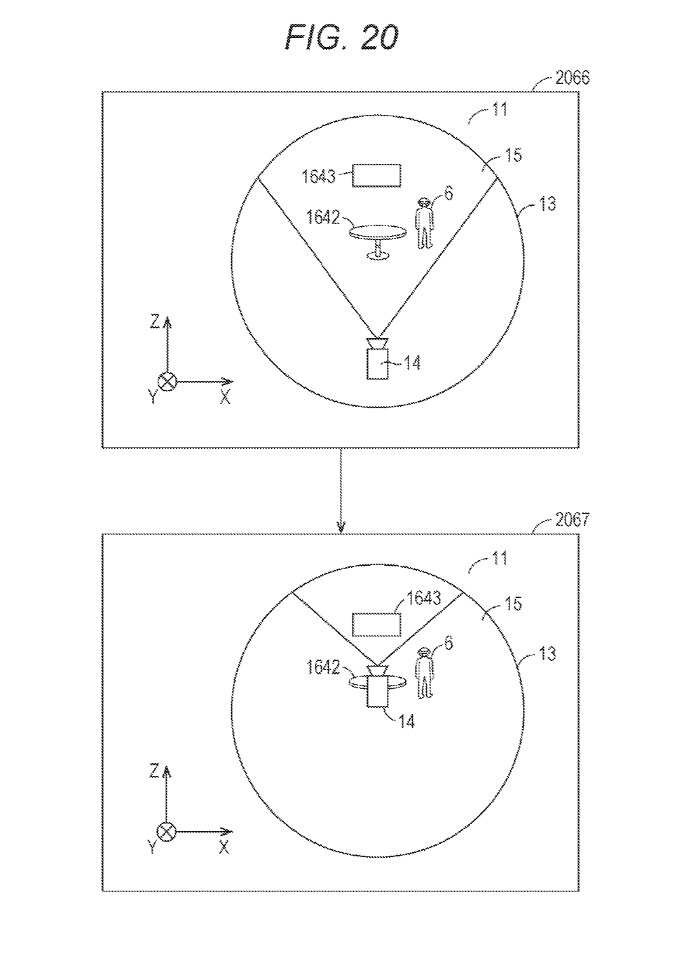

FIG. 20 is a diagram of an example of a second mode of change in relative positions of the virtual camera and the object according to at least one embodiment of this disclosure. In the second mode, the position of the object in the virtual space does not change, but the position of the virtual camera 14 changes.

In FIG. 20, two states 2066 and 2067 of the virtual space are illustrated. The positions of the objects 6, 1642, and 1643 do not change between the state 2066 and the state 2067, but the position of the virtual camera 14 changes. Under the state 2066, the virtual camera 14 is positioned near the bottom of the virtual space image 13, whereas, under the state 2067, the virtual camera 14 is positioned near the center of the virtual space image 13. As a result, the object 6 is positioned inside the field-of-view region 15 under the state 2066, whereas the object 6 is positioned outside the field-of-view region 15 under the state 2067.

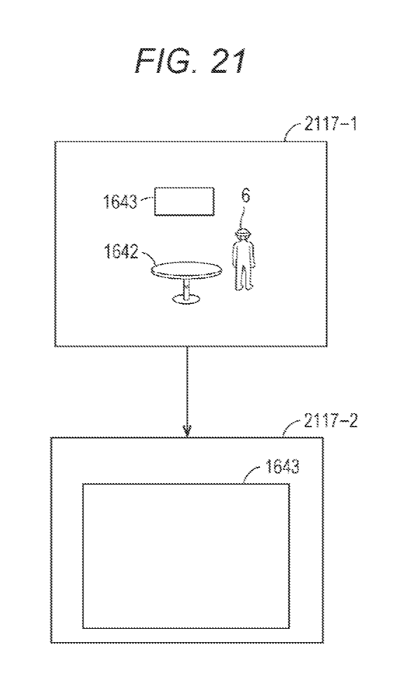

FIG. 21 is a diagram of a change in field-of-view image that follows change in relative positions of the virtual camera 14 and the object 6 illustrated in FIG. 20 according to at least one embodiment of this disclosure. FIG. 21 is an illustration of a field-of-view image 2117-1 corresponding to the state 2066 and a field-of-view image 2117-2 corresponding to the state 2067. The field-of-view image 2117-1 contains the objects 6, 1642, and 1643. On the other hand, the field-of-view image 2117-2 contains the object 1643, but does not contain the objects 6 and 1642.

In the above, a description has been given of the change in relative positions of the virtual camera 14 and the object 6 in the virtual space with reference to FIG. 19 to FIG. 21. In the virtual space, the relative positions of the virtual camera 14 and the object 6 may be changed also when the positions of both the virtual camera 14 and the object 6 have changed.

### Generation of Trajectory Object

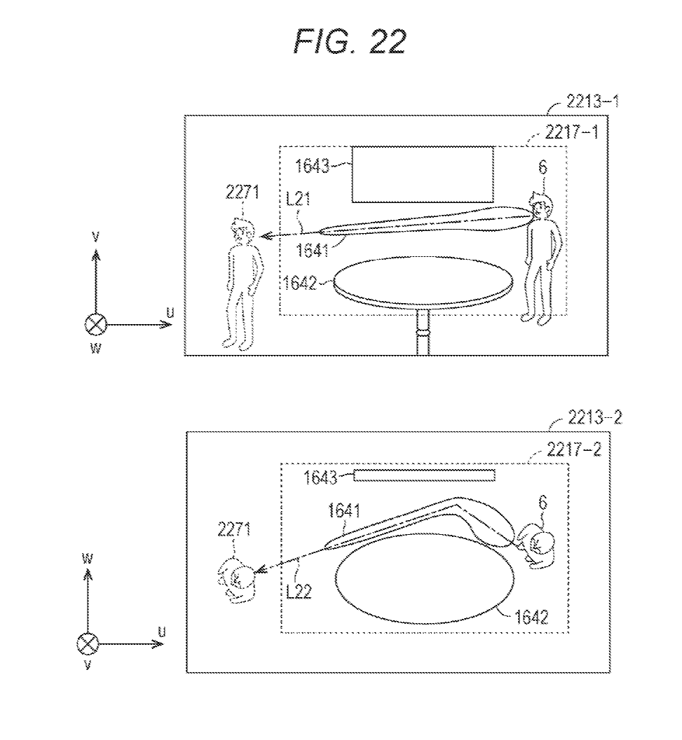

Referring to FIG. 22 to FIG. 24, a description is now given of generation of the trajectory object 1641 (FIG. 16).

FIG. 22 is a diagram of an example of a mode of setting the trajectory object 1641 according to at least one embodiment of this disclosure. In FIG. 22, a virtual space image 2213-1 represents a part of the virtual space image in a uv-plane. A virtual space image 2213-2 represents apart of the virtual space image in a uw-plane. The field-of-view images 2217-1 and 512 represent parts of the virtual space images 2213-1 and 2213-2 to be displayed as field-of-view images, respectively.

The object 6 moves in the virtual space images 2213-1 and 2213-2. An object 2271 represents the position of the object 6 after the movement.

The computer 200 sets the movement path of the object 6 based on the position of the object before (object 6) and after (object 2271) movement. In FIG. 22, a movement path L21 in the virtual space image 2213-1 and a movement path L22 in the virtual space image 2213-2 are illustrated as an example of the movement path.

As illustrated as the movement path L21, an example of the movement path connects the object before and after the movement by a straight line. As illustrated as the movement path L22, another example of the movement path connects the positions of the object before and after the movement so as to circumvent other objects (objects 1642 and 1643 in the field-of-view image.

The trajectory object 1641 represents movement of the object 6 to a position indicated by the object 2271, and includes at least a part of each of the movement paths L21 and L22. In at least one embodiment, a width of the trajectory object 1641 in a direction of crossing the movement paths L21 and L22 becomes larger as the trajectory object 1641 becomes closer to the object 2271. In other words, the width becomes larger as the trajectory object 1641 becomes closer to the object 2271. As a result, the movement direction is represented more clearly.

In at least one embodiment, the trajectory object 1641 is set so as not to pass through the inside of the object 1642 as illustrated in the virtual space image 2213-2. That is, the computer 200 sets the trajectory object 1641 so that the trajectory object 1641 does not overlap with the object 1642. When the trajectory object 1641 is set so as to pass through the inside of the object 1642, the user may feel strange about the movement of the object 6 that passes through the inside of the object 1642. The trajectory object 1641 is set to circumvent the object 1642, to thereby prevent the user from having such a strange feeling.

In at least one embodiment, as in the virtual space image 2213-1, the computer 200 sets the trajectory object 1641 so that the trajectory object 1641 does not overlap with the object 1643. The field-of-view image 2217-1 in the virtual space image 2213-1 represents a field of view set for an avatar object corresponding to the user of the HMD 120 provided with the field-of-view image 2217-1. The trajectory object 1641 is set so as not to overlap with the object 1643, to thereby prevent the trajectory object 1641 from obstructing the field of view of the avatar object toward the object 1643.

In at least one embodiment, the trajectory object 1641 overlaps with the object 1643 to some extent. For example, the computer 200 sets the trajectory object 1641 so that a percentage of the surface of the object 1643 overlapping with the trajectory object 1641 falls below a predetermined value (10%).

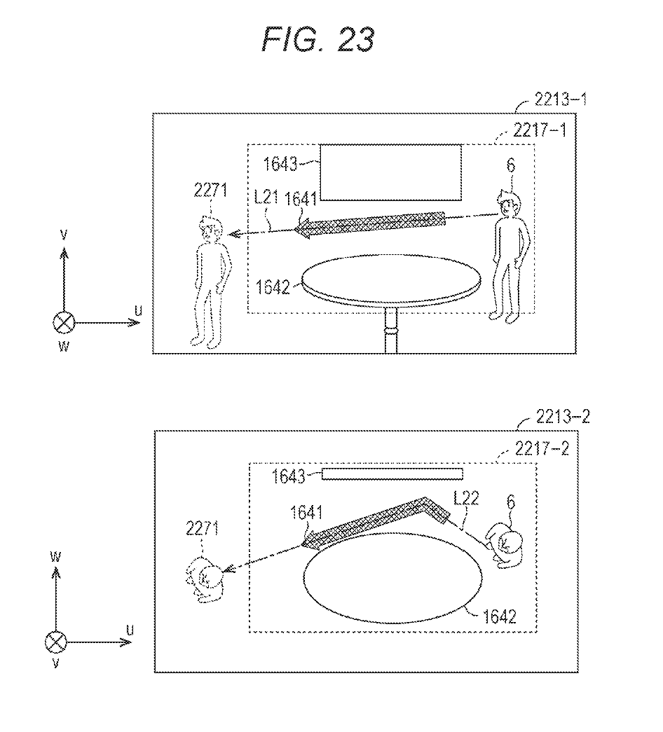

FIG. 23 is a diagram of another example of the mode of setting the trajectory object 1641 according to at least one embodiment of this disclosure. In the example illustrated in FIG. 22, the trajectory object 1641 has a hollow shape, whereas in the example illustrated in FIG. 23, the trajectory object 1641 is indicated as the arrow positioned on the movement paths L21 and L22. That is, the shape of the trajectory object 1641 may be an arrow.

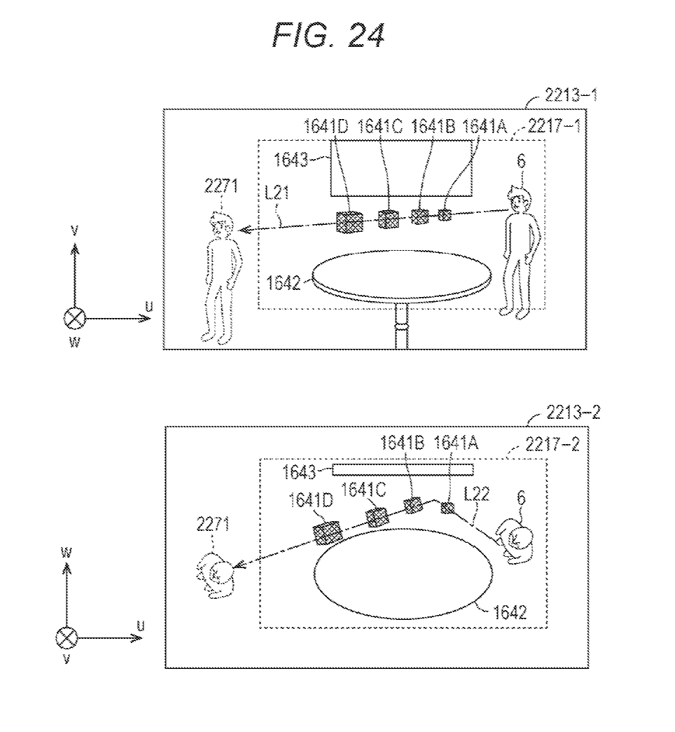

The trajectory object may be formed of a plurality of parts as in FIG. 24. In FIG. 24, as indicated in each of the virtual space images 2213-1 and 2213-2, the trajectory object includes four parts, namely, objects 1641A, 1641B, 1641C, and 1641D. The objects 1641A, 1641B, 1641C, and 1641D may be displayed at the same time, or may be displayed sequentially (e.g., in order from an object closest to the object 6).

The trajectory object may be formed of a moving avatar object itself. That is, in at least one embodiment, each of the objects 1641A, 1641B, 1641C, and 1641D of FIG. 24 has the same shape as that of the object 6. As a result, when the object 6 (avatar) moves from a position A to a position B (when position of object 6 and position of object 2271 in FIG. 24 are pinpointed), the computer 200 displays the object 6 in the virtual space in such a manner that the object 6 itself sequentially moves along the trajectory of from the position A to the position B. Each of the objects 1641A, 1641B, 1641C, and 1641D of FIG. 24 may have an enlarged or compressed shape of the object 6.

### Flow of Processing

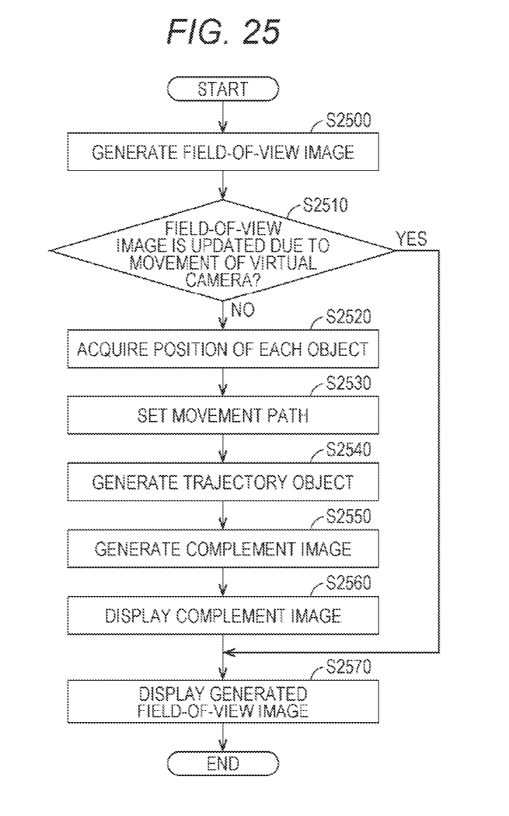

Referring to FIG. 25, a description is given of processing to be executed to display the complement image when the field-of-view image is updated. FIG. 25 is a flowchart of processing of displaying the complement image to be executed by the processor 210 according to at least one embodiment of this disclosure. The processing of FIG. 25 corresponds to the processing of the sub-routines of Step S1542 and Step S1570 of FIG. 15, and for example, is implemented by the processor 210 executing a given program.

In Step S2500, the processor 210 generates an updated field-of-view image based on a stare of a virtual user (Step S1542) or in response to a command from the server 600 (Step S1570).

In Step S2510, the processor 210 determines whether update of the field-of-view image is due to movement of the virtual camera 14.

For example, when update of the field-of-view image in Step S2500 is due to change in position of the virtual camera 14 as described with reference to FIG. 20, the processor 210 determines that update of the field-of-view image is due to movement of the virtual camera 14. The processor 210 updates the field-of-view image to move the virtual camera 14 based on, for example, the position and inclination of the HMD 120 (Step S1534 of FIG. 15), an operation of the controller 300 (Step S1550), and/or the line of sight (Step S1552) detected by the eye gaze sensor 140.

Movement of the virtual camera 14 is an example of movement of an avatar object corresponding to the virtual camera 14. In at least one embodiment, when a command to move an avatar object is given, the processor 210 moves the virtual camera in accordance with the movement of the avatar object. As a result, a field-of-view image corresponding to the position of the avatar object after the movement is provided as the field-of-view image.

On the other hand, for example, when update of the field-of-view image in Step S2500 is due to movement of an object as described with reference to FIG. 19, the processor 210 determines that update of the field-of-view image is not due to movement of the virtual camera 14. For example, when the processor 210 receives information indicating a movement path of the object from the server 600 (Step S1560 of FIG. 15), the processor 210 updates the field-of-view image to move the object in the virtual space.

More specifically, for example, the user 5B operates the controller 300B to move an object corresponding to the user 5B. The controller 300B transmits a signal indicating the operation to the computer 200B. The signal indicating the operation is transmitted to the computer 200 via the computer 200B and the server 600. When the processor 210 of the computer 200 acquires the signal, the processor 210 updates the field-of-view to move the object in the virtual space.

In Step S2510, when the processor 210 determines that update of the field-of-view image is due to movement of the virtual camera 14 (YES in Step S2510), the processor 210 advances the control to Step S2570. Otherwise (NO in Step S2510), the processor 210 advances the control to Step S2520.

In Step S2520, the processor 210 acquires the position of each object in the updated field-of-view image. The position of each object is acquired by, for example, referring to object information (FIG. 18).

In Step S2530, the processor 210 sets the movement path of the object. The movement path, is set in accordance with the mode illustrated in FIG. 22 or FIG. 23, for example.

In Step S2540, the processor 210 generates a trajectory object. The trajectory object is generated in accordance with the mode illustrated in FIG. 22 or FIG. 23, for example.

In Step S2550, the processor 210 generates a complement image. The complement image is generated by combining the updated field-of-view image generated in Step S2500 with the trajectory object generated in Step S140.

In Step S2560, the processor 210 displays the complement image generated in Step S2550 on the monitor 130. More specifically, the processor 210 outputs data (field-of-view image data) for displaying the complement image to the HMD 120. An example of the complement image is the field-of-view image 1617-2 of FIG. 16.

In Step S2570, the processor 210 displays the field-of-view image updated in Step S2500 on the monitor 130. More specifically, the processor 210 outputs data (field-of-view image data) for displaying the updated field-of-view image to the HMD 120. An example of the updated image is the field-of-view image 1617-3 of FIG. 16. After that, the processor 210 ends the processing of FIG. 25.

According to the processing of FIG. 25 described above, when the field-of-view image is updated through movement of an object in the virtual space, the processor 210 displays the complement image and then the updated field-of-view image on the monitor 130.

As described above with reference to FIG. 19, the complement image is displayed when the field-of-view image is updated through movement of an object in the virtual space. As described above with reference to FIG. 20, when the field-of-view image is updated through movement of the virtual camera 14, display of the complement image may be omitted. This configuration corresponds to executing the control of Step S2520 to Step S2560 when it is determined in Step S2510 that update of the field-of-view image is not due to the movement of the virtual camera 14 (NO in Step S2510), while avoiding executing the control of Step S2520 to Step S2560 when it is determined in Step S2510 that update of the field-of-view image is due to the movement of the virtual camera 14 (YES in Step S2510).

### SUMMARY OF DISCLOSURE

This disclosure is summarized in the following manner.

(1) In this disclosure, a computer 200A is connected to a plurality of head-mounted devices (HMDs 120A and 120B) directly or via a server 600. A method to be executed on a computer 200 to provide a virtual space includes defining a virtual space (Step S1510 of FIG. 15). In FIG. 12A, for example, the method includes arranging in the virtual space a first avatar object corresponding to a user of a first head-mounted device (HMD 120A) and a second avatar object (object 6) corresponding to a user of a second head-mounted device (HMD 120B) among the plurality of head-mounted devices. The method further includes presenting an image (field-of-view image 1617-1 of FIG. 16) that depends on a position of the first avatar object in the virtual space to the first head-mounted device. The method further includes presenting (Step S2560) a trajectory object trajectory object 1641) indicating a movement path of the second avatar object to the first head-mounted device based on an operation for moving the second avatar object (Step S2560).

A part and all of the steps defined in the method according to this disclosure may be executed by a processor other than the processor 210 of the computer 200, for example, the processor 610 of the server 600. That is, the processor 210 may be configured to present a field-of-view image transmitted from an external device without generating a field-of-view image.

According to this disclosure, when the second avatar object moves in the virtual space, the trajectory object indicating the movement path of the second avatar object is displayed. With this, the user can predict a movement destination of the second avatar object by visually recognizing the trajectory object. Therefore, VR sickness of the user may be reduced even when the position of the second object drastically changes in the virtual space.

(2) The above-mentioned method may further include switching, based on an operation for moving the first avatar object (operation for moving virtual camera 14), an image presented in the first head-mounted device to an image that depends on a position of the first avatar object after the movement (Step S2570, which is executed without execution of from Step S2520 to Step S2560 after Step S2510).

(3) The virtual space may include an object (object 1642) other than the first avatar object and the second avatar object. The trajectory object may be set so as to circumvent the object (trajectory object 1641 in virtual space image 2213-2).

(4) The virtual space may include an object (object 1643) other than the first avatar object and the second avatar object. The trajectory object may be set so that a percentage of obstruction of a field of view from the first avatar object toward the object falls below a predetermined value (trajectory object 1641 in virtual space image 2213-1).

It is to be understood that each of the embodiments disclosed herein is merely an example in all aspects and in no way intended to limit this disclosure. The scope of this disclosure is defined by the appended claims and not by the above description, and it is intended that this disclosure encompasses all modifications made within the scope and spirit equivalent to those of the appended claims. This disclosure described in each of the embodiments and each of the modification examples is intended to be implemented independently or in combination to the maximum extent possible.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

What is claimed is:

1. A method of providing a virtual space, the method comprising:
defining the virtual space, wherein the virtual space comprises a first avatar corresponding to a first user associated with a first head-mounted device (HMD) and a second avatar corresponding to a second user associated with a second HMD;
identifying a first position in the virtual space, wherein the first position is associated with the first avatar;
defining a visual field in the virtual space in accordance with the first position;
outputting a visual-field image corresponding to the visual field to the first HMD;
identifying a second position in the virtual space, wherein the second position is associated with the second avatar;
receiving a command to move the second avatar to a third position in the virtual space; and
displaying, in response to the reception of the command, a trajectory indicating movement of the second avatar from the second position to the third position in the visual-field image.

2. The method according to claim 1, further comprising:
identifying a movement path of the second avatar in accordance with a positional relationship between the second position and the third position;
arranging a trajectory object corresponding to the trajectory along the movement path in the virtual space; and
outputting the trajectory object to the visual-field image as the trajectory.

3. The method according to claim 2,
wherein the trajectory object is arranged in the virtual space so as to include at least a part of the movement path when viewed from above in the virtual space, and
wherein the trajectory object is arranged at a position of a height corresponding to a head of the second avatar when viewed from a horizontal direction in the virtual space.

4. The method according to claim 2,
wherein the movement path comprises a first path extending in a first direction and a second path extending in a second direction, and
wherein the trajectory object comprises a first part corresponding to the first path and a second part corresponding to the second path.

5. The method according to claim 2,
wherein the movement path comprises a first path extending in a first direction and a second path extending in a second direction,
wherein the trajectory object comprises a plurality of partial objects, and
wherein the plurality of partial objects comprise a first partial object corresponding to the first path and a second partial object corresponding to the second path.

6. The method according to claim 2,
wherein the virtual space further comprises a first object different from the first avatar and one second avatar, and
wherein the method further comprises:
defining a first movement path, which is a shortest distance between the second position and the third position;
determining intersection between the first movement path and the first object when viewed from above in the virtual space; and
defining a second movement path different from the first movement path, which is a movement path between the second position and the third position, in response co the intersection between the first movement path and the first object.

7. The method according to claim 6, wherein the second movement path and the first object are inhibited from intersecting with each other when viewed from above in the virtual space.

8. The method according to claim 2,
wherein the virtual space further comprises a second object different from the first avatar and the second avatar, and
wherein the method further comprises:
defining an observation visual-field image, which is a visual-field image that depends on the first position and is formed so as to include the second object;
defining a mode of display of the trajectory object so that a percentage of the trajectory object in the observation visual-field image is equal to or smaller than a threshold value;
generating the trajectory object that depends on the defined mode of display; and
arranging the generated trajectory object in the virtual space.
